(19) United States
(12) Patent Application Publication
(10) Pub. No.: US 2005/0174289 A1
(43) Pub. Date: Aug. 11, 2005

(54) Terrestrial wave receiving antenna device and antenna gain adjusting method

(76) Inventors: Hideaki Oshima, Minato-ku (JP); Yoichi Takeda, Minato-ku (JP)

Correspondence Address: RATNERPRESTIA, P O BOX 980, VALLEY FORGE, PA, 19482-0980, US

(21) Appl. No.: 10/516,398

(22) PCT Filed: Jun. 11, 2003
(86) PCT No.: PCT/JP03/07415

(30) Foreign Application Priority Data
Jun. 11, 2002 (JP) 2002-169467

(51) Int. Cl. H01Q 1/38

(52) U.S. Cl. 343/700 MS

(57) ABSTRACT

A ground wave reception antenna unit is provided, in which a directional gain during the reception of a vertically polarized wave does not decrease. The antenna unit comprises a planar antenna positioned inclining from a vertical direction and a reflector positioned in a horizontal direction or inclining from a horizontal direction by a predetermined angle with being spaced from the planar antenna by a predetermined distance. The reflector is positioned in close proximity to the planar antenna, or is positioned at a distance of integer multiples of 0.5λ, wherein λ is a wavelength of a ground wave received by the planar antenna.

### TECHNICAL FIELD

The present invention relates generally to a ground wave reception antenna unit and a method for adjusting a gain of the antenna unit, particularly to a ground wave reception antenna unit comprising an antenna body positioned inclining from a vertical direction and a method for adjusting a gain of such an antenna unit.

### BACKGROUND ART

There are some cases where an antenna body has to be positioned inclining from a vertical direction in view of circumstances where an antenna unit for receiving a wave (a vertically polarized wave) from a ground-based station is provided. One example is the case where a glass antenna for a vehicle is provided. Particularly, the slope of a front glass, a rear glass or the like of a vehicle is large so that the antenna body positioned on the glass is inevitably inclined.

In such a case, when a vertically polarized wave propagating in a horizontal direction is to be received, there is a problem in that a directional gain of an antenna tends to decrease, since an effective aperture area of the antenna decreases due to the slope of the antenna.

In FIGS. 1 and 2, there is shown an illustration for a vertically polarized wave directional gain decreasing due to the slope of an antenna. As shown in FIG. 1, where a front glass 12 on which a planar antenna 10 is formed is vertical, an essential effective aperture area of the planar antenna for a vertically polarized wave propagating in a horizontal direction is assumed to be S. Actually, as shown in FIG. 2, since the front glass 12 is sloped, assuming that an angle of slope (an angle of slope from a vertical directional) is θ, the effective aperture area in a horizontal direction becomes S×cos θ. In this way, even if the essential effective aperture area is S, when the antenna is inclined by θ, the effective aperture area for a vertically polarized wave in a horizontal direction becomes small such as S×cos θ. Thus, a vertically polarized wave directional gain decreases in a horizontal direction.

### DISCLOSURE OF THE INVENTION

An object of the present invention is to provide a ground wave reception antenna unit which does not cause a decrease in a directional gain during the reception of a vertically polarized wave even when an antenna is positioned inclining from a vertical direction.

Another object of the present invention is to provide a gain adjustment method for improving a directional gain at the time of a vertical polarized wave reception when an antenna is positioned inclining from a vertical direction.

The present invention uses a reflector positioned in a horizontal direction or inclining from the horizontal direction by a predetermined angle for an antenna positioned with being inclined so as to increase an effective aperture area of the antenna to a vertically polarized wave propagating in a horizontal direction, thereby improving a directional gain of the antenna. Moreover, a horizontal directional characteristic improved in this way becomes almost non-directional.

A first aspect of the present invention is a ground wave reception antenna unit comprising a planar antenna for receiving a vertically polarized wave propagating in a horizontal direction, the antenna being positioned inclining from a vertical direction, and a reflector positioned in a horizontal direction or inclining from the horizontal direction by a predetermined angle with being spaced from the planner antenna by a predetermined distance.

The predetermined angle is 0-30°, more preferably is 6°. As a result of experiments, it has been understood that a directional gain is improved in a range of 0-30° and a maximum directional gain is obtained at 6°.

In this ground wave reception antenna unit, the reflector is either positioned in close proximity to the planar antenna or is positioned such that a predetermined distance between the planar antenna and the reflector is integer multiples of 0.5λ, herein λ is a wavelength of a ground wave received by the planar antenna.

A second aspect of the present invention is a method for regulating a directional gain of a planar antenna in a ground wave reception antenna unit for receiving a vertical polarized wave propagating in a horizontal direction, the planar antenna being positioned inclining from a vertical direction, the method comprising the steps of positioning a reflector in a horizontal direction or with inclining from the horizontal direction by a predetermined angle while spacing the reflector from the planner antenna by a predetermined distance, and selecting the predetermined distance so that the directional gain is improved, comparing to a case where the reflector is not provided.

In this gain adjustment method, the reflector is either positioned in close proximity to the planar antenna or is positioned such that a predetermined distance between the planar antenna and the reflector is integer multiples of 0.5λ, herein λ is a wave length of the ground wave received by the planar antenna.

### BRIEF DESCRIPTION OF THE DRAWINGS

FIG. 1 is a view showing an illustration of a vertically polarized wave directional gain decreasing due to an inclination of an antenna;

FIG. 2 is a view showing an illustration of the vertically polarized wave directional gain decreasing due to an inclination of the antenna;

FIG. 3 is a view showing one embodiment of a ground wave reception antenna unit of the present invention;

FIG. 4 is a view showing an arrangement of a planar antenna and a reflector for performing a correlation estimate between a reflector distance L and a gain improvement effect;

FIG. 5 is a view showing an estimation result as to how a gain improvement effect is obtained by placing the reflector to be inclined from a horizontal direction in comparison with a state where no reflector is available;

FIG. 6 is a view showing a pattern of a planar antenna of a monopole type having a resonance frequency of 1.7 GHz;

FIG. 7 is a view showing a constitution in which the antenna is positioned inclining by 66° from a vertical direction and the reflector is positioned in close proximity to the lower end of a radiating element;

FIG. 8 is a view showing an arrangement of a radiating element and ground conductor;

FIG. 9 is a view showing a comparison result of horizontal direction vertical polarized wave directional gains between the antenna unit in which the reflector is provided and the antenna unit in which the reflector is not provided; and

FIG. 10 is a view showing an example where the antenna unit of the present invention is provided on a front glass of a vehicle.

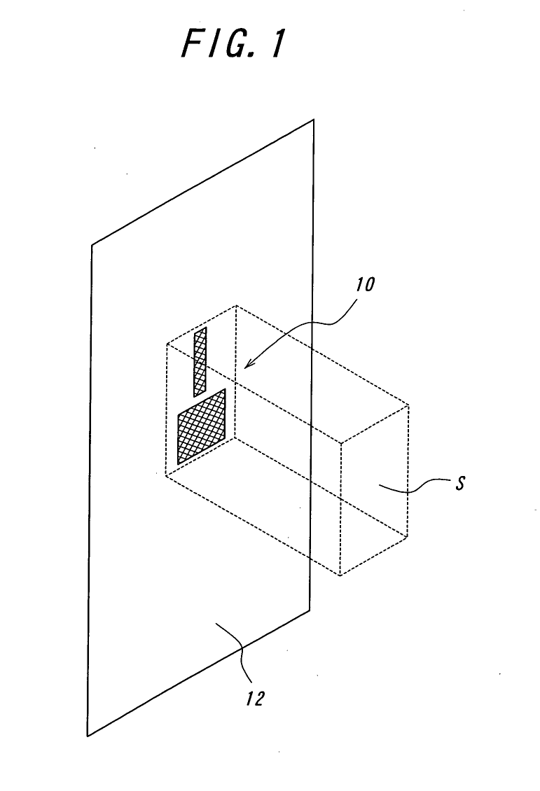

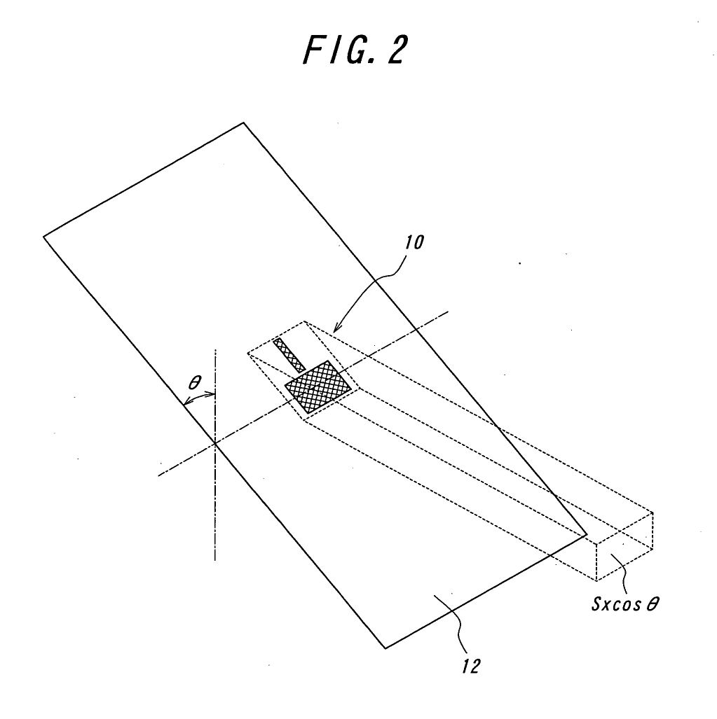

### BEST MODE FOR CARRYING OUT THE INVENTION

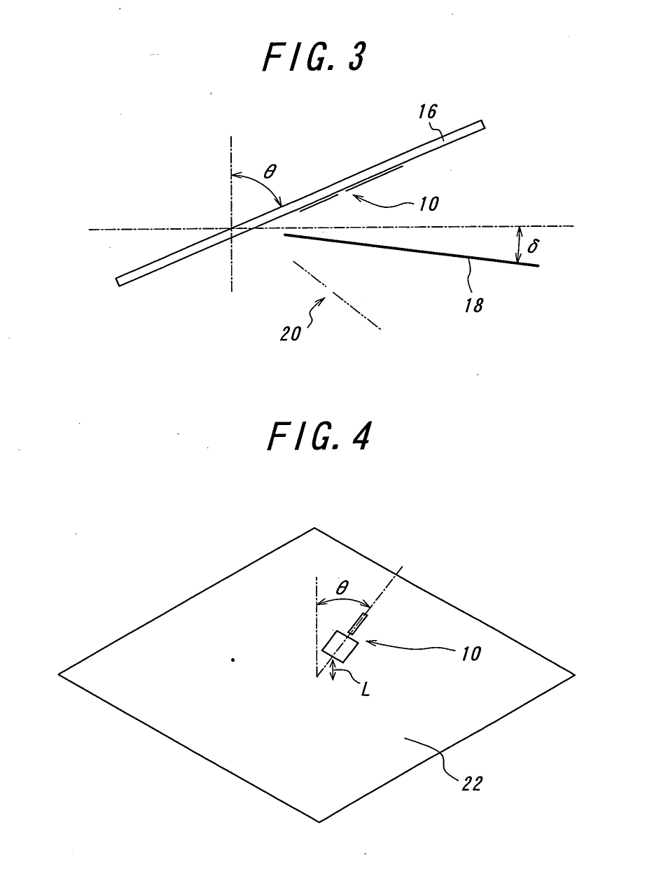

FIG. 3 shows one embodiment of a ground wave reception antenna unit of the present invention. A planar antenna 10 is provided on a glass plate 16 which is sloped by an angle of θ from a vertical direction. In the case where the antenna unit is mounted on a vehicle, the glass plate corresponds to a front glass or rear glass.

This ground wave reception antenna unit comprises a reflector positioned under the planar antenna 10, the reflector extending in a horizontal direction or inclining by an angle of δ (0-30°) from a horizontal direction with being spaced from the planar antenna. In this embodiment, the reflector is positioned inclining from a horizontal direction by 6°. A reflected image antenna 20 is formed by the reflector 18 positioned inclining from a horizontal direction, and an effective aperture area for a vertically polarized wave propagating in a horizontal direction apparently increases from S×cos θ, In this way, a directional gain for a vertically polarized wave in a horizontal direction is improved.

Further, since the reflector positioned described above has no portion to interrupt an emission characteristic in a horizontal direction, it is possible to make a vertically polarized wave directional gain in a horizontal direction thus obtained non-directional.

The inventors of the present application have made simulation experiments to see how gain improvement effects will be changed by a distance L between the reflector 18 and the planar antenna 10. Note that the distance L is measured in a vertical direction from the lower end of the planar antenna to the reflector 18.

FIG. 4 shows an arrangement of the planar antenna 10 and a reflector (an infinite plane) 22 for performing a correlation estimate (simulation) between the reflector distance L and a gain improvement effect. The angle θ of inclination of the planar antenna 10 is selected to 60°. The reflector 22 is positioned inclining from a horizontal direction by 6°.

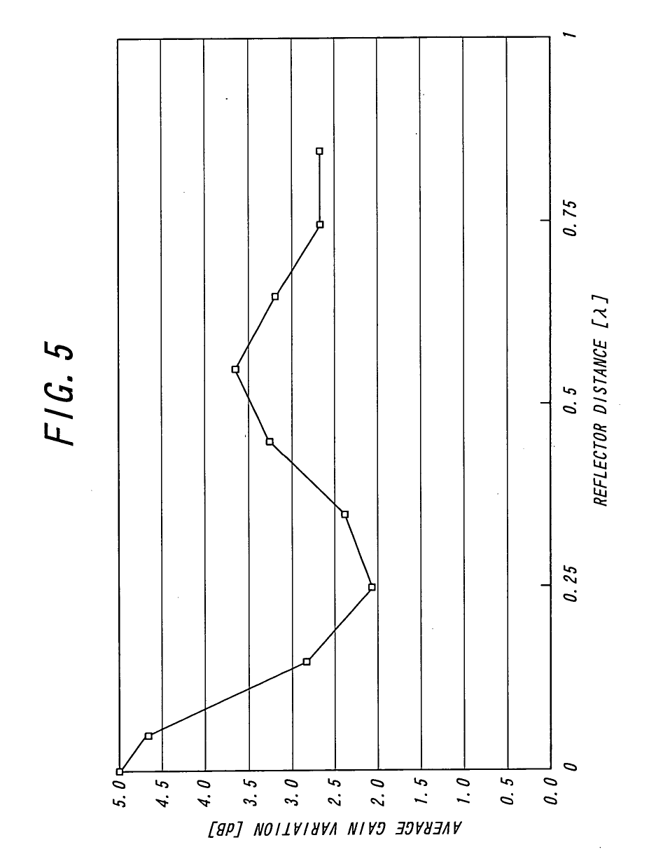

In FIG. 5, there is shown an estimation result as to how a gain improvement effect is obtained by placing the reflector in comparison with a state where no reflector is available. The abscissas shows the reflector distance L represented by a wavelength λ of a received radio wave, and the ordinate shows an average gain variation (dB). From this correlation estimate, it is clear that, when the reflector distance L is 0 or 0.5λ, the gain improvement effect takes the maximal value. Further, it is clear that, when the reflector distance L is 0, i.e., the reflector is placed directly under the antenna (but the reflector is not in contact with the antenna), the improvement level is about 5 dB, resulting in the maximum effect.

Hence, it is suitable for the reflector to be positioned directly under the antenna or arranged at a position of 0.5λ spaced from the antenna.

Further, estimating a vertically polarized wave average gain for the larger distance L, it is appreciated that maximal values are obtained at positions of integer multiples of 0.5λ, and these maximal value decreases as the distance L becomes larger. It is also possible, therefore, that the reflector is placed at positions of integer multiples of 0.5λ.

As an example, the case of improving a directional gain in the planar antenna of a monopole type formed on a glass surface will now be described.

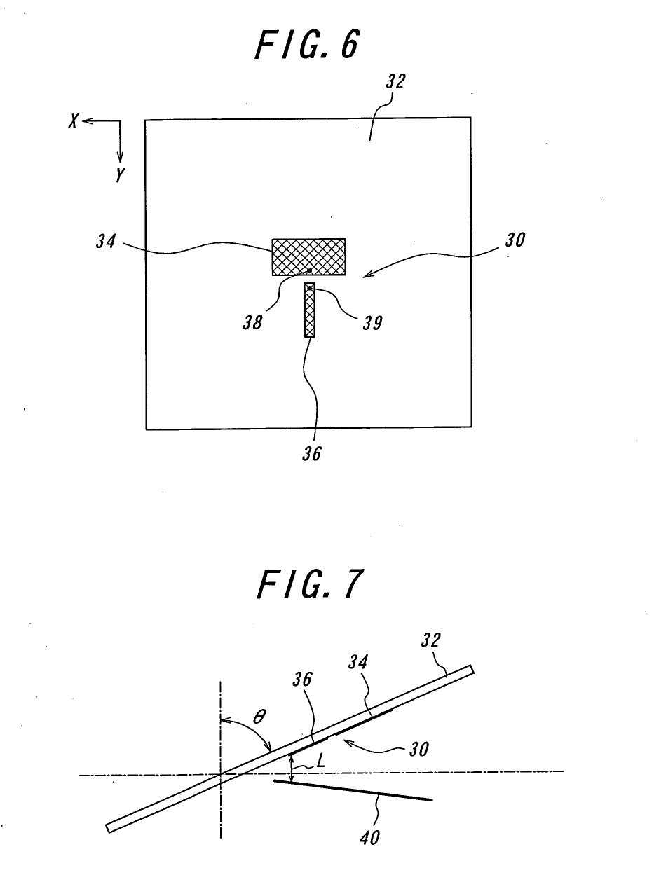

FIG. 6 shows a pattern of the planar antenna 30 of a monopole type having a resonance frequency of 1.7 GHz. This planar antenna 30 is formed on a square glass plate 32, and comprises a rectangular ground conductor 34 and an elongated radiating element 36. Feeding points 38, 39 are provided and connected to the radiating element and ground conductor, respectively.

In FIG. 7, there is shown a constitution in which such an antenna is positioned inclining by 66° from a vertical direction and a reflector 40 is positioned inclining by 6° from a horizontal direction.

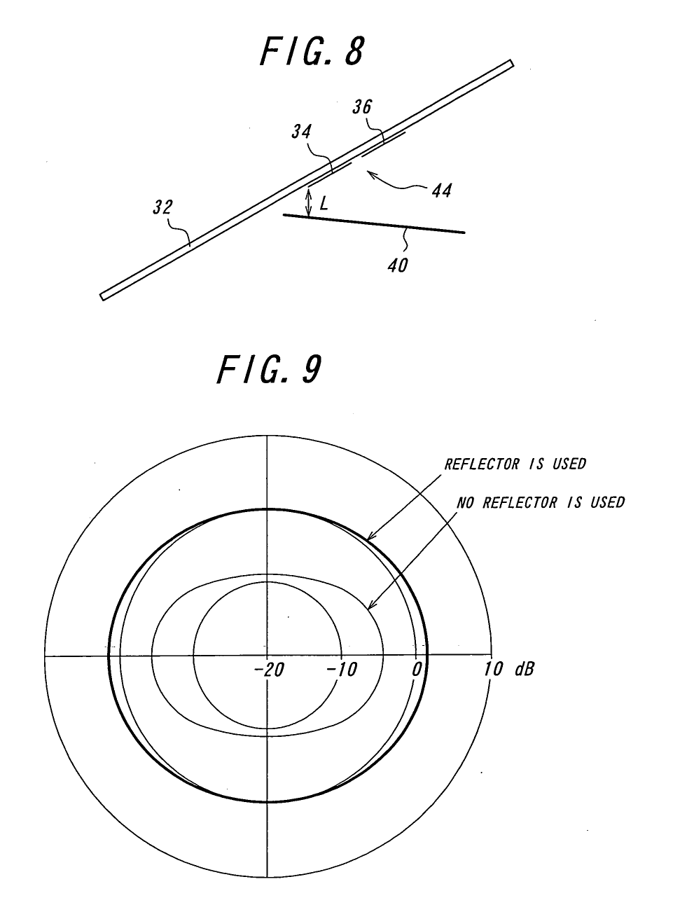

Whether the radiating element 36 is positioned in proximity of the reflector 40 as shown in FIG. 7 or the ground conductor 34 is positioned in proximity of the reflector 40 depends on the position where the planar antenna is provided on a window glass of a vehicle, for example. In FIG. 8, there is shown such an example that a planar antenna 44 in which the ground conductor 34 is positioned in proximity to the reflector 40. In this case, the distance L is a length from the lower end of the ground conductor 34 to the reflector 40.

For the antenna unit in which the reflector 40 is positioned in close proximity to the lower end of the earth conductor 34 in the antenna unit of FIG. 7 and the antenna unit in which the reflector 40 is not provided in FIG. 7, a comparison result of respective horizontal direction vertical polarized wave directional gains is shown in FIG. 9.

The average gain is −7 dB where the reflector is not used, and 1 dB where the reflector is used. It is clear that, by using the reflector, the directional gain of the horizontal direction vertical polarized wave is improved by 8 dB on an average. It is also clear that a favorable characteristic of a non-directionality is obtained.

Hence, in the case where such an antenna unit is mounted on a vehicle, the above-described planar antenna is provided on the inner surface of a sloped window glass (for example, a front glass or a rear glass) of a vehicle, and the reflector is positioned under this planar antenna.

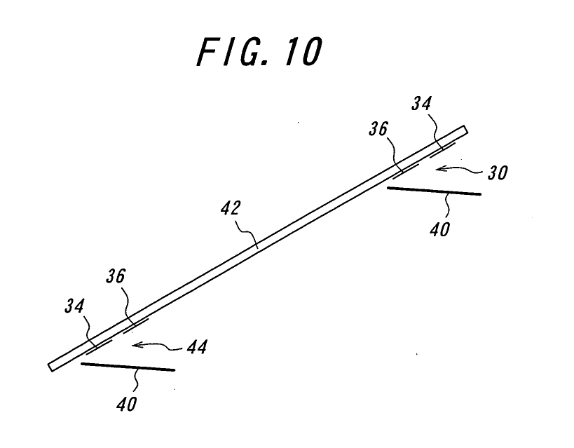

FIG. 10 shows the positions where the antenna unit of the present embodiment may be provided on the front glass 42 of a vehicle. In the case where the antenna unit is attached to the upper inside portion of the front glass 42, the radiating element 36 is positioned in proximity to the reflector 40, and in the case where an antenna unit is attached to the lower inside portion of the front glass 42, the ground conductor 34 is positioned in proximity to the reflector 40.

The reason why such an arrangement is carried out is that the ground conductor 34 is easily connected to a body portion of a vehicle on the upper inside portion or lower inside portion of the front glass 42, since a body portion of a vehicle works as an earth conductor.

### INDUSTRIAL APPLICABILITY

According to the present invention, a reflected image antenna is formed by a reflector positioned in a horizontal direction or inclining from a horizontal direction by a predetermined angle, and, in this way, an antenna effective aperture area for a vertical polarized wave propagating in a horizontal direction can be increased. Hence, even when an antenna body is inclined, a large directional gain can be obtained for the vertical polarized wave propagating in a horizontal direction. Therefore, even when an antenna body is positioned inclining from a vertical direction, a ground wave reception antenna unit may be implemented in which the directional gain during the reception of a vertically polarized wave does not decrease. Furthermore, a directional gain adjusting method for improving a directional gain during the reception of a vertically polarized wave when an antenna body is positioned inclining from a vertical direction.

1. A ground wave reception antenna unit, comprising:
a planar antenna for receiving a vertically polarized wave propagating in a horizontal direction, said antenna being positioned inclining from a vertical direction; and
a reflector positioned in at least one of a horizontal direction or inclining from the horizontal direction by a predetermined angle and being spaced from said planar antenna by a predetermined distance.

2. The ground wave reception antenna unit according to claim 1, wherein said reflector is positioned in close proximity to said planar antenna.

3. The ground wave reception antenna unit according to claim 1, wherein a distance between said planar antenna and said reflector is an integer multiple of 0.5λ, λ being a wave length of the ground wave received by said planar antenna.

4. The ground wave reception antenna unit according to claim 1, wherein said predetermined angle is 0-30°.

5. The ground wave reception antenna unit according to claim 4, wherein said predetermined angle is 6°.

6. The ground wave reception antenna unit according to any one of claims 1 to 5, wherein said planar antenna is positioned on an inner surface of a front glass or rear glass of a vehicle and said reflector is positioned under said planar antenna.

7. The ground wave reception antenna unit according to claim 6, wherein said planar antenna includes a radiating element and ground conductor positioned on the inner surface of the front glass or rear glass of a vehicle.

8. A method for regulating a directional gain of a planar antenna in a ground wave reception antenna unit for receiving a vertical polarized wave propagating in a horizontal direction, said planar antenna being positioned inclining from a vertical direction, said method comprising the steps of:
positioning a reflector in at least one of a horizontal direction or inclining from the horizontal direction by a predetermined angle while spacing said reflector from said planner antenna by a predetermined distance, and
selecting said predetermined distance so that the directional gain is improved, comparing to a case where said reflector is not provided.

9. The method according to claim 8, wherein said step of selecting said predetermined distance includes a step of positioning said reflector in close proximity to said planar antenna.

10. The method according to claim 8, wherein said step of selecting said predetermined distance includes selecting a predetermined distance between said planar antenna and said reflector to be an integer multiple of 0.5λ, λ being a wave length of the ground wave received by said planar antenna.

11. The method according to claim 8, wherein said predetermined angle is 0-30°.

12. The method according to claim 11, wherein said predetermined angle is 6°.

13. The method according to any one of claims 8-12, wherein said planar antenna is positioned on an inner surface of a front glass or rear glass of a vehicle.

14. The method according to claim 13, wherein said planar antenna includes a radiating element and a ground conductor positioned on the inner surface of the front glass or rear glass of a vehicle.
